(19) United States
(12) Patent Application Publication
(10) Pub. No.: US 2026/0136230 A1
(43) Pub. Date: May 14, 2026

(54) EMPLOYING A MIDDLEBOX TO PROVIDE CONNECTIVITY FEATURES FOR A RADIO ACCESS NETWORK

(71) Applicant: Microsoft Technology Licensing, LLC, Redmond, WA (US)

(72) Inventors: Xenofon FOUKAS, Cambridge (GB); Tenzin Samten UKYAB, Berkeley, CA (US); Bozidar RADUNOVIC, Cambridge (GB)

(73) Assignee: Microsoft Technology Licensing, LLC, Redmond, WA (US)

(21) Appl. No.: 19/051,021

(22) Filed: Feb. 11, 2025

Related U.S. Application Data
(60) Provisional application No. 63/719,362, filed on Nov. 12, 2024.

(51) Int. Cl. H04W 28/02; H04B 7/024; H04L 5/00

(52) U.S. Cl. CPC H04W 28/0215; H04B 7/024; H04L 5/0094

(57) ABSTRACT

This document relates to techniques for providing connectivity features in a radio access network. For instance, the disclosed techniques can employ a middlebox to process fronthaul traffic relating to communications between distributed units and radio units of a radio access network. The processing can provide various connectivity features, such a distributed antenna system connectivity feature, a distributed multiple-input and multiple-output connectivity feature, and/or a radio unit sharing feature that involves sharing of a particular radio unit among two or more distributed units. The processing can also provide an application programming interface for accessing scheduling information, signal quality measurements, buffer status, random access attempts, and/or network load relating to the fronthaul traffic.

### BACKGROUND

By utilizing cellular technologies, radio access networks (RANs) can provide various benefits relatively to other wireless communication technologies. For instance, in a WiFi system, decentralized sharing of unlicensed spectrum can result in collisions and dropouts, as well as dropped connections for moving devices that move out of range of a given WiFi network. However, RANs are built on cellular technologies that use centralized allocation of licensed spectrum, and support maintaining connections as devices move from one cell to another. Thus, RANs can provide higher reliability than WiFi, particularly for moving devices.

In a traditional radio access network (RAN), a centralized base station is employed for baseband processing of signals. The base station communicates with one or more radio units (RUs) having associated antennas to provide user equipment with access to a core network, such as a 4G or 5G network. While traditional RANs provide enhanced reliability relative to WiFi, traditional RANs tend to utilize tightly integrated, vendor-specific hardware. This can result in high cost while also limiting the flexibility of a given RAN deployment. More recently, centralized RAN architectures are being replaced with virtualized radio access networks (vRANs), where distributed units (DUs) that implement baseband processing are deployed on the edge. In a vRAN, the DUs communicate with a centralized unit (CU) that coordinates access to a core network. vRANs use software to implement network functions instead of proprietary hardware, which allows for scalability, rapid deployment, and reduced costs.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for providing connectivity features on radio access networks. One example includes a computer-implemented method that can include receiving, by the middlebox, fronthaul traffic relating to communications between one or more distributed units and one or more radio units of a radio access network. The method can also include processing the fronthaul traffic with the middlebox, the processing resulting in processed fronthaul traffic that provides one or more connectivity features in the radio access network. The method can also include communicating the processed fronthaul traffic from the middlebox to the one or more distributed units and the one or more radio units.

Another example includes a computing device comprising a hardware processing unit and a storage resource storing computer-readable instructions which, when executed by the hardware processing unit, cause the computing device to implement a middlebox. The middlebox can be configured to receive fronthaul traffic relating to communications between one or more distributed units and one or more radio units of a radio access network. The middlebox can also be configured to process the fronthaul traffic to implement one or more connectivity features in the radio access network, the processing resulting in processed fronthaul traffic that provides one or more connectivity features in the radio access network. The middlebox can also be configured to communicate the processed fronthaul traffic to the one or more distributed units and the one or more radio units.

Another example includes a computer-readable storage medium storing executable instructions which, when executed by a processor, cause the processor to perform acts. The acts can include receiving, by the middlebox, fronthaul traffic relating to communications between one or more distributed units and one or more radio units of a radio access network. The acts can also include processing the fronthaul traffic with the middlebox, the processing resulting in processed fronthaul traffic that provides one or more connectivity features in the radio access network. The acts can also include communicating the processed fronthaul traffic from the middlebox to the one or more distributed units and the one or more radio units.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system that provides a radio access network for access by multiple client devices, consistent with some implementations of the present concepts.

FIG. 2A illustrates an example of an architecture for a radio unit in a RAN, consistent with some implementations of the present concepts.

FIG. 2B illustrates an example of an architecture for a distributed unit in a RAN, consistent with some implementations of the present concepts.

FIG. 2C illustrates an example of an architecture for a centralized unit in a RAN, consistent with some implementations of the present concepts.

FIG. 2D illustrates an example of an architecture for a RAN middlebox, consistent with some implementations of the present concepts.

FIG. 3A illustrates an example of a downlink configuration for a RAN middlebox to provide a distributed antenna system, consistent with some implementations of the present concepts.

FIG. 3B illustrates an example of an uplink configuration for a RAN middlebox to provide a distributed antenna system, consistent with some implementations of the present concepts.

FIG. 3C illustrates an example of a distributed antenna system provided in a building, consistent with some implementations of the present concepts.

FIG. 4A illustrates an example of a configuration for a RAN middlebox to provide distributed MIMO functionality, consistent with some implementations of the present concepts.

FIG. 4B illustrates an example of distributed MIMO functionality provided in a building, consistent with some implementations of the present concepts.

FIG. 5 illustrates an example of a configuration for a RAN middlebox to provide radio unit sharing functionality, consistent with some implementations of the present concepts.

FIG. 6 illustrates an example of a configuration for a RAN middlebox to concurrently provide radio unit sharing functionality, distributed antenna functionality, and distributed MIMO functionality, consistent with some implementations of the present concepts.

FIG. 7 illustrates an example method or technique, consistent with some implementations of the present concepts.

FIG. 8 illustrates an example graphical user interface for configuring a RAN middlebox, consistent with some implementations of the present concepts.

### DETAILED DESCRIPTION

As noted above, vRANs provide a great deal of flexibility relative to traditional RAN deployments. By virtualizing RAN functionality, software can be used to customize a given RAN deployment and adapt to changes over time without necessarily replacing or adding hardware. Moreover, RAN hardware has been trending toward more open architectures where standardized interfaces are used for communication between individual devices. This allows for interoperability between devices produced by different vendors.

For instance, Open RAN specifies standards for fronthaul traffic between the RU and DU in a vRAN. As discussed more below, the RU generally handles lower-level radio frequency (RF) processing while the DU handles baseband processing tasks. The communication between the RU and DU is standardized so that an RU from one vendor will work with a DU from another vendor.

However, while vRANs have greatly increased the flexibility and interoperability of RAN deployments, vRANs still have certain limitations. For instance, certain advanced connectivity features are not currently available for vRANs, and only tightly-integrated, vendor-specific solutions are available. The disclosed implementations employ a RAN middlebox that acts as an intermediary between RUs and DUs to provide advanced RAN connectivity features. For instance, as described more below, the RAN middlebox can process fronthaul traffic using software to implement a distributed antenna system, distributed multiple-input and multiple-output (MIMO), and/or sharing of RUs by multiple DUs.

### Terminology

As used herein, the term “radio unit” or “RU” refers to a component of a RAN that handles radio-frequency processing, such as converting baseband digital signals into analog RF signals for transmission by an antenna, converting analog RF signals received by the antenna into baseband digital signals, etc. The term “distributed unit” or “DU” refers to a component of a RAN that communicates baseband digital signals with one or more RUs. A DU can handle certain functions in the RAN such as medium access control, radio link control, etc. The term “centralized unit” or “CU” refers to a component of a RAN that provides access from the RAN to a core network. A CU can handle higher-level functionality in the RAN such as ensuring reliable data transport, quality of service, and mobility management in the RAN.

The term “fronthaul” traffic refers to traffic communicated to/from one or more RUs to one or more DUs in a RAN, e.g., real-time radio data. The term “midhaul” traffic refers to traffic communicated to/from one or more DUs in a RAN to one or more CUs. The term “backhaul” traffic refers to traffic communicated to/from one or more CUs to a core network.

The term “middlebox” refers to device and/or software module that processes fronthaul traffic in a RAN. For instance, a middlebox can be implemented using software on a dedicated server that is connected (e.g., by a hard-wired connection such as fiber) to one or more RUs and one or more DUs. In some cases, middlebox software is implemented on the same physical device as one or more other components of a given RAN. For instance, a server can execute a middlebox software module as well as one or more other modules that implement DUs. In this case, the middlebox can use shared memory to communicate with the DUs.

### Example Ran System

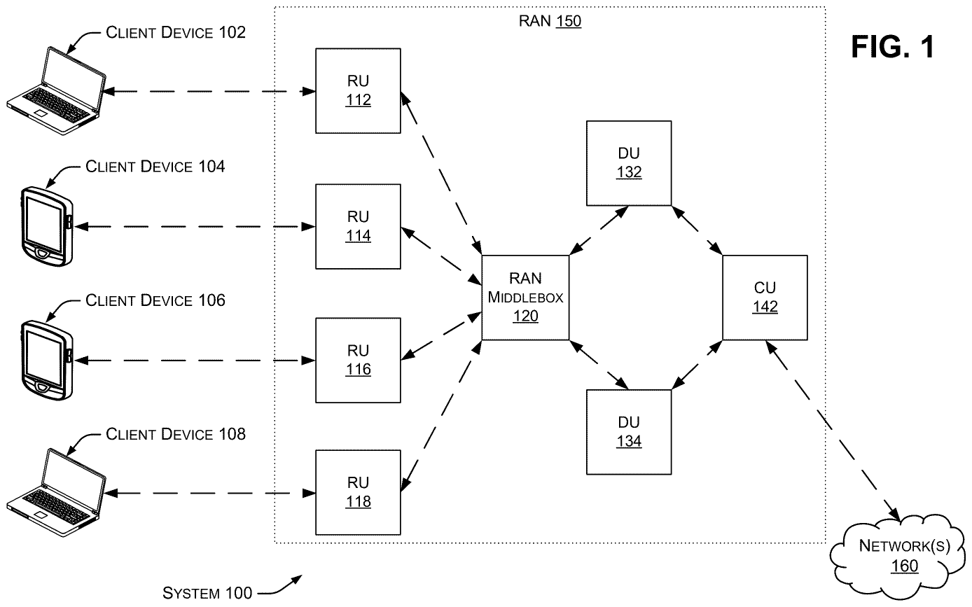

FIG. 1 shows an example system 100 in which the present implementations can be employed, as discussed more below. Note that FIG. 1 shows only one example system and that the present concepts can be implemented in a wide range of technical environments.

As shown in FIG. 1, system 100 includes a client device 102, a client device 104, a client device 106, a client device 108, an RU 112, an RU 114, an RU 116, an RU 118, a RAN middlebox 120, a DU 132, a DU 134, and a CU 142. Collectively, the RUs, RAN middlebox, and DUs make up a RAN 150 that can allow the client devices to have radio access to one or more networks 160 (e.g., a 5G core network).

Client device 102 can send and receive signals using radio frequencies to/from RU 112, client device 104 can send and receive signals using radio frequencies to/from RU 114, client device 106 can send and receive signals using radio frequencies to/from RU 116, and client device 108 can send and receive signals using radio frequencies to/from RU 118. The respective RUs can perform analog to digital processing on signals received from the client devices, and digital to analog processing on signals received from the RAN middlebox 120. For instance, the RUs can convert signals received from the client devices to baseband frequency domain (e.g., via Fast Fourier Transform or “FFT” operations) and provide the frequency domain signals to the RAN middlebox 120 (e.g., in-phase and quadrature or “IQ” data). Likewise, the respective RUs can receive baseband frequency domain signals from the RAN middlebox and convert the frequency domain signals to time domain (e.g., via Inverse Fast Fourier Transform or “IFFT” operations) for transmission to the client devices.

Note that FIG. 1 shows a one-to-one correspondence between client devices and RUs, but this is for illustrative purposes only. In practice, a given RU can provide access to RAN 150 to multiple client devices at any given time. Furthermore, the RU that a given client device communicates with can change over time, e.g., as the client device moves and/or as other changes occur in RAN 150.

As described more below, RAN middlebox 120 can receive fronthaul traffic communicated among the respective RUs and DUs of RAN 150. The RAN middlebox can process the fronthaul traffic using various techniques described below to provide certain connectivity features. For instance, the RAN middlebox can provide a distributed antenna connectivity feature, a distributed multiple-input and multiple-output (MIMO) connectivity feature, and/or an RU sharing connectivity feature that allows multiple DUs to share a single DU.

### Example Ran Device Architectures

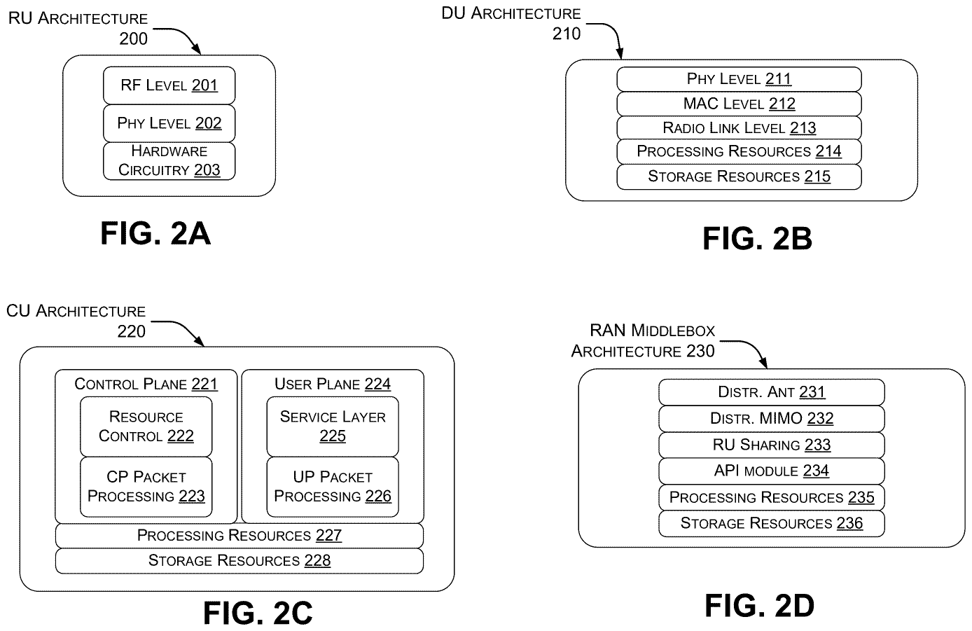

FIG. 2A shows an RU architecture 200 that can be implemented by each of RU 112, RU 114, RU 116, and RU 118. RU architecture 200 can include RF level 201 and physical level 202. RF level 201 can include analog processing, such as receiving or transmitting analog RF signals over the air, amplification, filtering, and frequency conversion. For instance, the RF level can convert baseband signals received from a DU into carrier frequency signals that are transmitted into the air, and can convert carrier frequency signals that are received over the air into baseband signals that are sent to a DU. Physical level processing can include orthogonal frequency division (“OFDM”) processing, beamforming, etc. The RF level and physical level can be implemented in hardware circuitry 203. The hardware circuitry can include hardware logic, such as Field-programmable Gate Arrays (FPGAs), Application-specific Integrated Circuits (ASICs), etc. for RF signal processing. The hardware circuitry can also include power amplifiers and digital-to-analog converters to convert baseband signals to RF signals for transmission, and low-noise amplifiers and analog-to-digital converters to convert received RF signals to baseband. The hardware circuitry can also include logic for physical level processing as well as provide functionality such as one or more network interfaces for communicating with the RAN middlebox 120.

FIG. 2B shows a DU architecture 210 that can be implemented by each of DU 132 and DU 134. DU architecture 210 includes physical level 211, MAC level 212 (media access control), and radio link level 213. Physical level 211 can perform baseband signal processing such as modulation/demodulation, error correction of raw bits/symbols, coding and decoding, etc. MAC level 212 can perform scheduling of transmissions, allocate resources such as time slots or frequencies, etc. Radio link level 213 can ensure reliable delivery over a radio link by performing packet-level error correction, retransmission, assembly of data packets, ensuring in-sequence delivery of packets, etc. The DU architecture also includes processing resources 214 and storage resources 215. The processing resources 214 can include processing units such as central processing units (CPUs). The storage resources 215 can include both persistent storage resources, such as magnetic or solid-state drives, and volatile storage, such as one or more random-access memory devices. In some cases, the physical level, MAC level, and radio link level can be provided as executable instructions that are stored on persistent storage devices, loaded into the random-access memory devices, and read from the random-access memory by the processing resources for execution by the processing resources.

FIG. 2C shows a CU architecture 220 that can be implemented by CU 142. CU architecture 220 includes control plane 221 that implements resource control 222 and control plane packet processing 223. The resource control involves allocating radio resources to user devices, quality of service processing, session and mobility management, etc. The control plane packet processing can involve routing signaling packets to/from a given DU to network(s) 160, where the signaling packets are employed to provide functions such as session and mobility management.

CU architecture also includes user plane 224 with service layer 225 and user plane packet processing 226. The service layer can manage user sessions with the network(s) 160, support maintaining sessions when client devices move across cells, etc. The user plane packet processing can perform packet forwarding and processing of packets having user plane data.

The CU architecture also includes processing resources 227 and storage resources 228. The processing resources 227 can include processing units such as central processing units (CPUs). The storage resources 228 can include both persistent storage resources, such as magnetic or solid-state drives, and volatile storage, such as one or more random-access memory devices. In some cases, the control plane and user plane can be provided as executable instructions that are stored on persistent storage devices, loaded into the random-access memory devices, and read from the random-access memory by the processing resources for execution by the processing resources.

FIG. 2D shows a RAN middlebox architecture 230 that can be implemented by RAN middlebox 120. The RAN middlebox architecture includes a distributed antenna module 231, a distributed MIMO module 232, an RU sharing module 233, and an API module 234. The RAN middlebox can perform operations described below that involve processing fronthaul traffic communicated among the RUs and the DUs. The processing can provide connectivity features such as a distributed antenna system, distributed multiple-input and multiple-output (MIMO) functionality, RU sharing among distributed units, and/or providing an application programming interface for accessing scheduling information, signal quality measurements, buffer status, random access attempts, or network load relating to the fronthaul traffic.

The RU architecture also includes processing resources 235 and storage resources 236. The processing resources 235 can include processing units such as central processing units (CPUs). The storage resources 236 can include both persistent storage resources, such as magnetic or solid-state drives, and volatile storage, such as one or more random-access memory devices. In some cases, the distributed antenna module, distributed MIMO module, RU sharing module, and API module can be provided as executable instructions that are stored on persistent storage devices, loaded into the random-access memory devices, and read from the random-access memory by the processing resources for execution by the processing resources.

In addition, note that system 100 illustrates certain devices performing certain functions, but other implementations can implement functionality of multiple devices shown in FIG. 1 on a single device. For instance, in some cases, the DUs and RAN middlebox are implemented as different software modules on the same physical computing device. Thus, the term “middlebox” does not necessarily imply a separate device but rather refers to functionality relating to virtualization of connectivity features. In other implementations, functionality discussed with respect to one device shown in FIG. 1 can be distributed across multiple devices. For instance, multiple RAN middlebox devices can be provided, with one device providing a distributed antenna system, another device providing distributed MIMO, a third device implementing RU sharing by multiple DUs, and so on.

### Example Distributed Antenna System

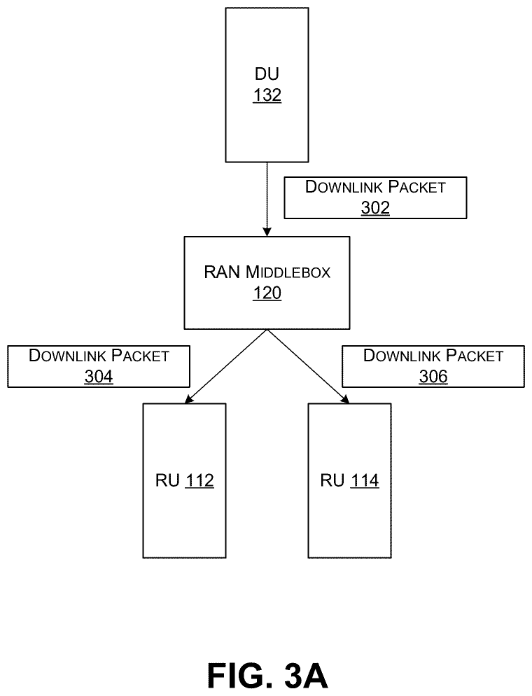

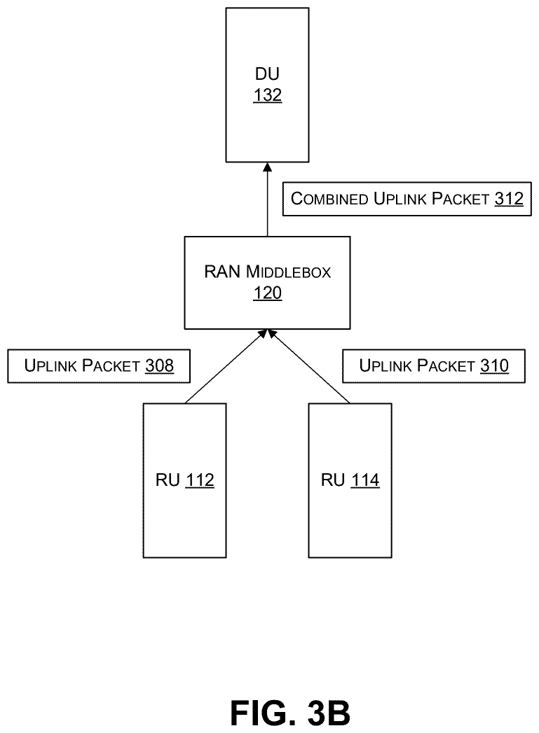

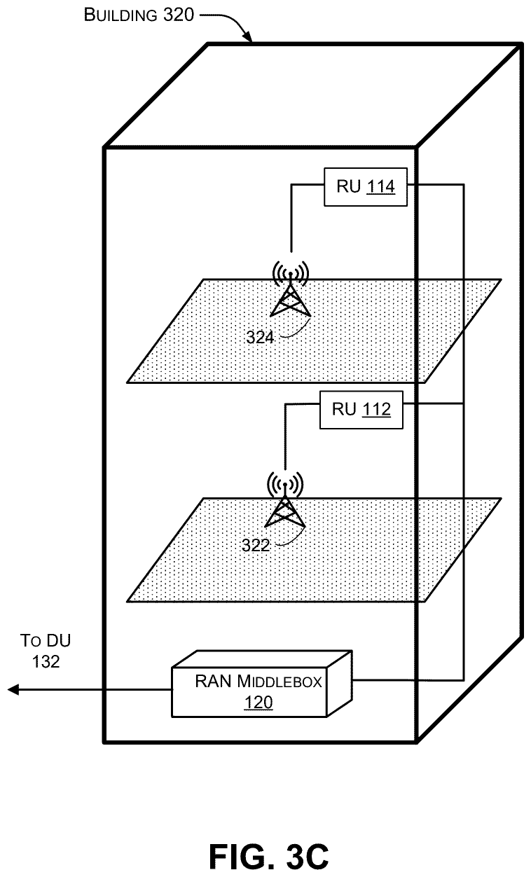

FIGS. 3A and 3B show how distributed antenna module 321 on RAN middlebox 120 can provide a distributed antenna system, with FIG. 3A illustrating a downlink configuration and FIG. 3B illustrating an uplink configuration. Generally speaking, a distributed antenna system can have several advantages over a traditional centralized antenna system where a single centralized antenna is designated to cover a large area. By using a distributed antenna system, each antenna can cover a smaller area and provide better coverage with reduced interference and noise.

FIG. 3A shows how packet mirroring can be employed for downlink packets to achieve a distributed antenna system. In FIG. 3A, DU 132 sends downlink packet 302 to the RAN middlebox 120, which mirrors downlink packet 302 as downlink packet 304 and downlink packet 306. From the perspective of the DU, it appears as if there is a single RU. Thus, for instance, DU 132 can communicate with client device 102 and client device 104 at separate times, or in a single transmission.

For the following example, assume that client device 102 is allocated 10 physical resource blocks (PRBs) 0 through 9 and client device 104 is allocated another 10 PRBs, 10 through 19. Each PRB can include a specified number (e.g., 12) of subcarriers. The DU can provide baseband IQ data on a per-subcarrier basis for retransmission by the respective RUs.

First, assume DU 132 wishes to send a first packet with data for client device 102 but not client device 104. The first packet can include IQ data for PRBs 0-9, with null values for PRBs 10 through 19. The RAN middlebox 120 can mirror this first packet so that it is transmitted over the air by both RU 112 and RU 114. Since the first packet only includes IQ data for PRBs allocated to client device 102, client device 104 may ignore the first packet. Said another way, each client device only listens for IQ data in its assigned PRBs, and ignores IQ data from other PRBs. Thus, client device 104 can ignore the first packet, while client device 102 can extract symbols from PRBs 0 through 9 and process the first packet accordingly.

Next, assume DU 132 wishes to send a second packet with data for client device 104 but not client device 102. The second packet can include IQ data for PRBs 10 through 19, with null values for PRBs 0 through 9. The RAN middlebox 120 can mirror this second packet so that it is transmitted over the air by both RU 112 and RU 114. Since the second packet only includes IQ data for PRBs allocated to client device 104, client device 102 may ignore the second packet. The client device 104 can extract symbols from PRBs 10 through 19 and process the second packet accordingly.

Next, assume DU 132 wishes to send a third packet with data for both client device 102 and client device 104. The third packet can include IQ data for PRBs 0 through 9 representing the data intended for client device 102 and IQ data for PRBs 10 through 19 representing the data intended for client device 104. The RAN middlebox 120 can mirror this third packet so that it is transmitted over the air by both RU 112 and RU 114. Client device 102 can ignore the data in PRBs 10 through 19, and client device 104 can ignore the data in PRBs 0 through 9. Client device 102 can extract symbols from PRBs 0 through 9 and process the data accordingly. Client device 104 can extract symbols from PRBs 10 through 19 and process the data accordingly.

The previous description illustrated a relatively simple example where three packets were transmitted consecutively using 5G PRBs that did not change over time. More generally, however, different client devices can have different allocated resources at the physical level that can change over time. For instance, each client device can have different frequency and/or time resources that the client devices use to communicate with the RAN 150. Because the client devices know which physical resources are allocated to them for any given packet transmitted by a given RU, the packet mirroring by RAN middlebox 120 can enable multiple RUs to be employed by a single DU. Note that packet mirroring can be performed for both control plane and user plane packets.

FIG. 3B illustrates how uplink packets can be combined to achieve a distributed antenna system. Continuing with the previous example, assume that client device 102 is allocated 10 physical resource blocks (PRBs) 0 through 9 and client device 104 is allocated PRBS 10 through 19. In FIG. 3B, RU 112 sends uplink packet 308 to the RAN middlebox and RU 114 sends uplink packet 310 to the RAN middlebox 120. Assume that uplink packet 308 was transmitted by client device 102 and includes IQ samples for PRBs 0 through 9 and null values for PRBs 10 through 19. Further, assume that uplink packet 310 was transmitted by client device 104 and includes IQ samples for PRBs 10 through 19 and null values for PRBs 0 through 9.

The RAN middlebox combines the uplink packets to obtain combined uplink packet 312, which is then sent to the DU 132. For example, the combined uplink packet can be obtained by summing the IQ samples in the uplink packets 308 and 310 in an element-wise manner, e.g., on a sub-carrier basis, and include the summed IQ samples in the combined uplink packet. If the received uplink packets are compressed, the RAN middlebox can decompress the packets, sum the IQ samples, and then compress the summed IQ samples to include in the combined uplink packet. Thus, the combined uplink packet will include the IQ samples for PRBs 0 through 9 from the transmission by client device 102, as well as the IQ samples for PRBs 10 through 19 for the transmission by client device 104. The DU 132 can separate the combined uplink packet to obtain the respective data transmitted by the different client devices.

FIG. 3C shows how a distributed antenna system can be provided in a building 320. A first antenna 322 associated with RU 112 is deployed on a first floor of the building, and a second antenna 324 associated with RU 114 is deployed on a second floor of the building. Client devices on the first floor can communicate with RAN 150 via RU 112 and antenna 322, and client devices on the second floor can communicate with RAN 150 via RU 114 and antenna 324. RAN middlebox 120 can be provided inside building 320, although this is not necessarily the case. Further, while FIG. 3C shows traffic from RAN middlebox 120 being sent to DU 132 outside of building 320, other implementations can provide the RAN middlebox and one or more DUs on the same physical computing device.

### Example Distributed Mimo

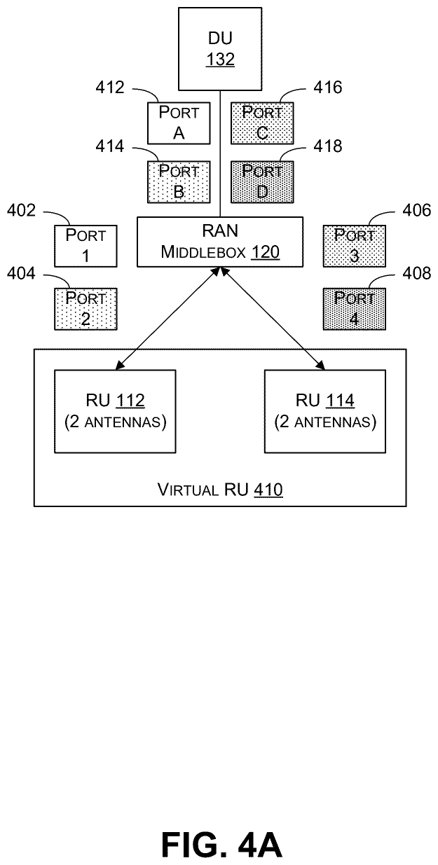

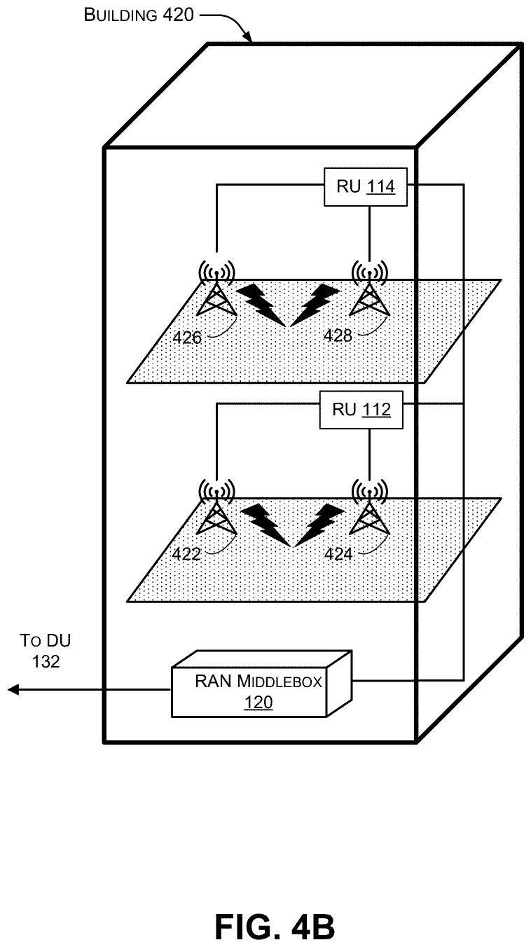

FIG. 4A shows how distributed MIMO module 232 on RAN middlebox 120 can provide distributed MIMO functionality. Distributed MIMO functionality can allow antennas in different locations to provide reliable coverage to many different client devices with increased capacity. Generally, the distributed MIMO can work by spatially multiplexing data streams using focused RF beams where constructive interference is employed to improve the signal-to-noise ratio of signals at receiving devices. For instance, the RF beams can be focused using beamforming or beam steering techniques. These techniques can involve manipulating the phase of signals transmitted by individual array elements of a phased array antenna, or, in some cases, by mechanical means (e.g., orientation of a parabolic antenna).

Referring to FIG. 4A, assume that both RU 112 and RU 114 have two antennas each, with a corresponding antenna port. RU 112 has antenna port 402 and antenna port 404, and RU 114 has antenna port 406 and antenna port 408. The RAN middlebox 120 provides a virtual RU 410 with four virtual antenna ports to DU 132-virtual antenna port 412, virtual antenna port 414, virtual antenna port 416, and virtual antenna port 418. As conveyed by the patterns in FIG. 4A, the RAN middlebox can perform port remapping to provide the virtual RU. For instance, as shown in FIG. 4A, physical antenna port 402 of RU 112 is mapped to virtual antenna port 412, physical antenna port 404 of RU 112 is mapped to virtual antenna port 414, physical antenna port 406 of RU 114 is mapped to virtual antenna port 416, and physical antenna port 408 of RU 114 is mapped to virtual antenna port 418.

From the perspective of DU 132, there is a single virtual RU with four antenna ports. To transmit signals, the DU can perform MIMO precoding of baseband digital signals and send them to the RAN middlebox 120. The RAN middlebox can distribute the baseband signals according to the port mappings. Thus, the RAN middlebox can provide a virtual RU with a total number of antennas up to the sum of the antennas that available to the set of physical RUs.

For instance, assume the DU 132 prepares four packets to send to the virtual RU 410 provided by the RAN middlebox 120. A first packet includes a first header that includes a first port identifier of virtual antenna port 412 and a first payload that includes a first baseband signal to transmit via virtual antenna port 412. A second packet includes a second header that includes a second port identifier of virtual antenna port 414 and a second payload that includes a second baseband signal to transmit via virtual antenna port 414. A third packet includes a third header that includes a third port identifier of virtual antenna port 416 and a third payload that includes a third baseband signal to transmit via virtual antenna port 416. A fourth packet includes a fourth header that includes a fourth port identifier of virtual antenna port 418 and a fourth payload that includes a fourth baseband signal to transmit via virtual antenna port 418.

The RAN middlebox can map the four packets to the four physical antenna ports by modifying the headers and distributing the packets as follows. The first packet is rewritten to modify the first header by replacing the identifier of virtual antenna port 412 with the identifier of physical antenna port 402. The second packet is rewritten to modify the second header by replacing the identifier of virtual antenna port 414 with the identifier of physical antenna port 404. The third packet is rewritten to modify the third header by replacing the identifier of virtual antenna port 416 with the identifier of physical antenna port 406. The fourth packet is rewritten to modify the fourth header by replacing the identifier of virtual antenna port 418 with the identifier of physical antenna port 408. The modified first and second packets are sent from the RAN middlebox 120 to RU 112, and the modified third and fourth packets are sent from the RAN middlebox 120 to RU 114. The payloads of each packet (e.g., the baseband signals) can remain the same. The respective RUs can implement beam steering techniques to form beams that direct the RF signals to the respective client devices. In some implementations, the RAN middlebox can also copy synchronization signal block (SIB) information (such as master information block or system information block data) from the first packet to the other packets. This can help the client devices to remain synchronized.

A similar mapping approach can be employed for received signals. The RU 112 can convert a first RF signal received at physical antenna port 402 to a first baseband signal and send a first packet to the RAN middlebox 120. The first packet can have a first header that includes a first port identifier of physical antenna port 402 and a first payload that includes the first baseband signal. The RU 112 can convert a second RF signal received at physical antenna port 404 to a second baseband signal and send a second packet to the RAN middlebox 120. The second packet can have a second header that includes a second port identifier of physical antenna port 404 and a second payload that includes the second baseband signal.

The RU 114 can convert a third RF signal received at physical antenna port 406 to a third baseband signal and send a third packet to the RAN middlebox 120. The third packet can have a third header that includes a third port identifier of physical antenna port 406 and a third payload that includes the third baseband signal. The RU 114 can convert a fourth RF signal received at physical antenna port 408 to a fourth baseband signal and send a fourth packet to the RAN middlebox 120. The fourth packet can have a fourth header that includes a fourth port identifier of physical antenna port 408 and a fourth payload that includes the fourth baseband signal.

The RAN middlebox 120 can map the first baseband signal to virtual antenna port 412, the second baseband signal to virtual antenna port 414, the third baseband signal to virtual antenna port 416, and the fourth baseband signal to virtual antenna port 418. The RAN middlebox can do this as follows. The first packet can be modified to replace the identifier of the physical antenna port 402 with the identifier of virtual antenna port 412. The modified first packet can be sent to the DU 132 with the first payload (e.g., first baseband signal) unmodified. The second packet can be modified to replace the identifier of the physical antenna port 404 with the identifier of virtual antenna port 414. The modified second packet can be sent to the DU 132 with the second payload (e.g., second baseband signal) unmodified. The third packet can be modified to replace the identifier of the physical antenna port 406 with the identifier of virtual antenna port 416. The modified third packet can be sent to the DU 132 with the third payload (e.g., third baseband signal) unmodified. The fourth packet can be modified to replace the identifier of the physical antenna port 408 with the identifier of virtual antenna port 418. The modified fourth packet can be sent to the DU 132 with the fourth payload (e.g., fourth baseband signal) unmodified.

FIG. 4B shows how distributed MIMO functionality can be provided in building 420. A first antenna 422 and a second antenna 424 associated with RU 112 are deployed on a first floor of the building. A third antenna 426 and a fourth antenna 428 associated with RU 114 are deployed on a second floor of the building. RU 112 can employ antenna 422 and antenna 424 to create constructive interference for beam steering of directed RF signals to individual client devices on the first floor. RU 114 can employ antenna 426 and antenna 428 to create constructive interference for beam steering of directed RF signals to individual client devices on the second floor.

### Example RU Sharing

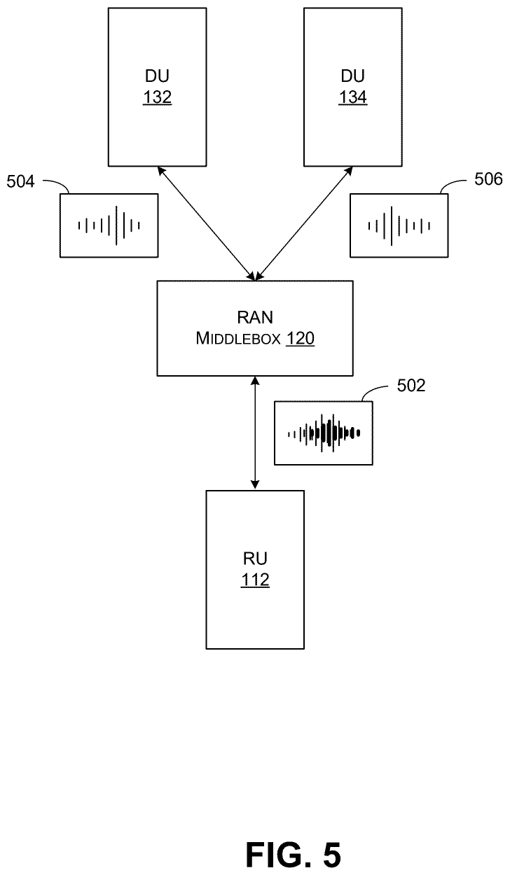

FIG. 5 shows how RU 112 can be shared by DU 132 and DU 134 via RU sharing module 233 on RAN middlebox 120. Typically, if a RAN deployment wants to allow access to core networks for two different providers, then there will be separate RUs in the RAN deployment for each provider. The following describes how a single RU can be shared by two DUs. Each DU can provide access to a different core network (e.g., through the same CU or a different CU) by sharing an RU as follows.

Assume RU 112 employs a frequency band 502 (e.g., 100 MHz). The RAN middlebox 120 divides frequency band 502 into a subband 504 for DU 132 and a subband 506 for DU 134. For instance, the subbands can be 40 MHz subbands, separated by a 20 MHz subband (e.g. a guard band). Each DU can be assigned approximately 106 PRBs. The RAN middlebox can multiplex downlink messages from the DUs and demultiplex uplink messages from the RU to implement RU sharing as follows.

Considering downlink transmissions first, assume DU 132 sends a first packet to the RAN middlebox 120 with IQ data for 106 PRBs in subband 504, and DU 134 sends a second packet to the RAN middlebox 120 with IQ data for 106 PRBs in subband 506. The RAN middlebox can combine the payloads of these packets into a single packet with null IQ values for PRBs in the 20 MHz guard band and send that packet to RU 112.

Considering uplink transmissions next, assume RU 112 receives transmissions over the air and generates a single packet with IQ samples in both subband 504 and subband 506. The RU sends the packet to the RAN middlebox 120. The RAN middlebox 120 demultiplexes this packet to create two new packets, a first packet with the IQ samples for subband 504 and a second packet with the IQ samples for subband 506. The RAN middlebox sends the first packet to DU 132 and the second packet to DU 134.

One particular use case for RU sharing involves providing a neutral host. For instance, assume a building owner wishes to provide 5G access to two different cell providers with different core networks. One DU can be assigned to each cell provider while the cell providers share a single RU. Note that in this case, separate CUs may be provided for each cell provider, although this is not necessarily the case.

Note that the previous discussion assumes that the PRBs employed by DU 132 are aligned to a corresponding subset of PRBs employed by RU 112, and the PRBs employed by DU 134 are aligned to another subset of PRBs employed by RU 112. However, this is not necessarily the case. In some implementations, PRB alignment can be performed as follows. Select the offset from PRB 0 where the DU's spectrum should begin, prb_offset. Then, the derivation of the DU's center of frequency, DU_center_of_frequency, is as follows:

$$PRB\_ 0 \_frequency = RU\_center \_of \_frequency - \qquad ( 1 )$$

$$12 \times SCS \times \frac{RU\_num \_prb}{2} \qquad ( 2 )$$

$$\begin{matrix}DU\_center \_of \_frequency = PRB\_ 0 \_frequency + & ( 3 )\end{matrix}$$

$$12 \times SCS \times ( prb\_offset + \frac{DU\_num \_prb}{2} ) \qquad ( 4 )$$

where SCS is the subcarrier spacing and num_prb is the number of PRBs of the DU or RU's full spectrum. In other implementations, instead of performing PRB alignment, the RAN middlebox can decompress data received from the DUs in their respective PRBs, copy, and recompress the data into the PRBs employed by the RU.

### Example Combined Connectivity Features

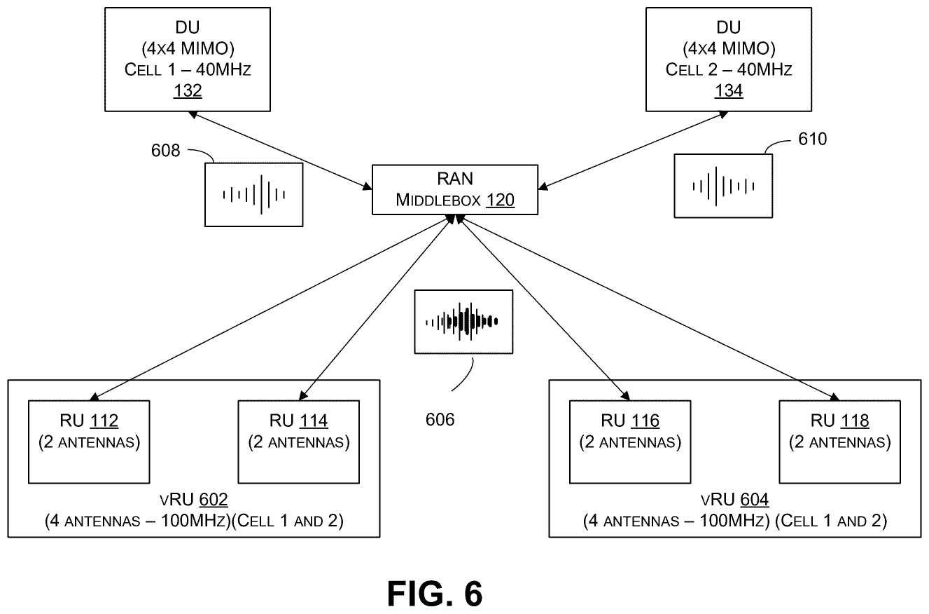

FIG. 6 shows how RAN middlebox 120 can concurrently provide a distributed antenna, distributed MIMO functionality, and RU sharing. By concurrently providing these connectivity features, the RAN middlebox can achieve the various advantages of each of these features described above.

RAN middlebox 120 provides a virtual RU 602 and a virtual RU 604. Virtual RU 602 includes two physical RUs-RU 112 and RU 114, and virtual RU 604 includes two physical RUs-RU 116 and RU 118. The physical RUs all employ a frequency band 606, e.g., 100 MHz.

The RAN middlebox 120 divides frequency band 606 into a subband 608 for DU 132 and a subband 610 for DU 134. For instance, the subbands can be 40 MHz subbands, separated by a 20 MHz subband (e.g. a guard band). As discussed previously with respect to FIG. 5, each DU can be assigned approximately 106 PRBs. The RAN middlebox can multiplex downlink messages from the DUs and demultiplex uplink messages from the RU to implement RU sharing as described above.

The RAN middlebox 120 can implement distributed antenna functionality as described above. For instance, assume DU 132 sends a downlink packet to the RAN middlebox 120 with IQ samples in its assigned subband 608. The RAN middlebox can mirror those packets so that all four physical RUs-RU 112, RU 114, RU 116, and RU 118-generate transmissions based on the IQ data. For uplink transmissions, the RAN middlebox can combine the IQ samples for PRBs assigned to different client devices and provide a combined packet to the DU 132, e.g., by summing of IQ samples as described previously.

For distributed MIMO, the RAN middlebox can implement port mapping by providing each DU with the ability to control 8 virtual antenna ports. The respective DUs can send baseband signals to the virtual antenna ports conveying messages to individual client devices within the respective PRBs assigned to those client devices. The RAN middlebox 120 can map those baseband signals from virtual port identifiers employed by DU 132 and DU 134 to physical antenna port identifiers employed by RU 112, RU 114, RU 116, and RU 118, respectively. The respective RUs can implement beam forming/steering to direct corresponding RF signals to the respective client devices.

### Additional Implementations

In the examples described above, the RAN middlebox 120 distributed baseband samples among different RUs and DUs without necessarily modifying the underlying baseband signal itself. However, in further implementations, the RAN middlebox can directly manipulate the baseband signal for various purposes. Consider a scenario where a particular floor temporarily has a dramatic increase in network traffic. An existing cell may cover multiple floors of the building and lack capacity to provide high quality service to everyone in the building.

The RAN middlebox 120 can create a new cell for the floor of the building. Then, the RAN middlebox can intentionally reduce the magnitude of IQ samples that are transmitted to the client devices on the busy floor by the old cell. The client devices will report the degraded signal quality to the RAN (e.g., to a DU or CU), and then a handover will be initiated to the newly-created cell.

In addition, referring back to FIG. 2D, the RAN middlebox architecture 230 provides an API module 234. The API module can provide access to various information regarding RAN 150. For instance, by monitoring the fronthaul traffic communicated among the RUs and DUs in RAN 150, the API module can provide access to statistics that convey conditions on the RAN at a given time, or an average over a period of time. For instance, the API module can provide scheduling information indicating which PRBs or subcarriers are assigned to individual client devices at different times. The API module can also provide signal quality measurements such as signal-to-noise ratio or other channel quality information relating to channel conditions at different RUs. The API module can also provide information relating to buffer status, e.g., whether buffers on a given DU or CU are getting full or overflowing, latency information, etc. The API module can also provide other information, such as information relating to random access attempts, network load relating to the fronthaul traffic, etc. This information can be employed for diagnostic purposes to identify problems on the RAN, for capacity planning purposes to determine whether to add new DUs or RUs to the RAN, or other purposes.

In some cases, the API module 234 extracts IQ samples from the fronthaul traffic to extraction the various types of information discussed above. This approach involves overhead for decompressing and decoding the IQ samples. In other implementations, the API module can estimate PRB utilization by evaluating compression information in the uplink and downlink user plane packets, without necessarily decompressing and/or decoding these packets. The following algorithm can be employed when Block Floating Point compression information is available:

Algorithm 1 PRB Utilization Estimation Algorithm

Require: Fronthaul packets containing PRB data
Ensure: Bitvector PRB_Utilized populated with utilization status

| | |
|---|---|
| 1 | Initialize PRB_Utilized as an empty bitvector |
| 2 | for each PRB in Fronthaul_samples do |
| 3 | Extract Exponent from PRB's BFP header |
| 4 | if Packet is Downlink then |
| 5 | PRB_Utilized[PRB] := (Exponent > thr_dl) |
| 6 | else if Packet is Uplink then |
| 7 | PRB_Utilized[PRB] := (Exponent > thr_ul) |
| 8 | end if |
| 9 | end for |
| 10 | Expose PRB_Utilized to external applications through telemetry |
| | interface |

A PRB can be marked as utilized if its BFP exponent is above some threshold, e.g., 0 in the downlink and 2 in the uplink, and otherwise it is marked as idle.

As a final point, note that the RAN middlebox 120 can be implemented as software at various layers of a software stack. For instance, in some implementations, the RAN middlebox can utilize a set of application programming interfaces that bypass the kernel (e.g., Data Plane Development Kit for Linux operating systems). In other cases, the RAN middlebox can use application programming interfaces that interact with the operating system kernel (e.g., eXpress Data Path for Linux operating systems).

### Example Method

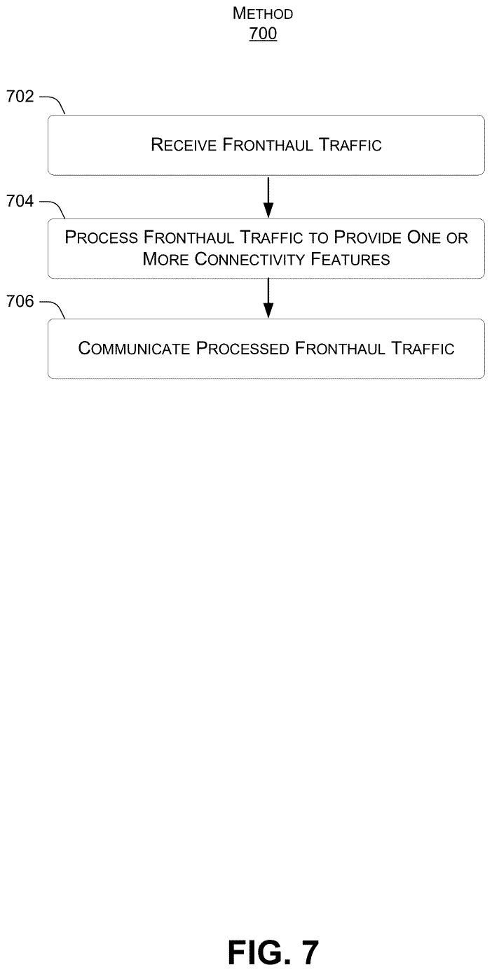

FIG. 7 illustrates an example computer-implemented method 700, consistent with the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where fronthaul traffic is received by a middlebox. For instance, the middlebox can be implemented on a computing device with a wired (e.g., fiber) or wireless connection to one or more distributed units and one or more radio units of a RAN. In some cases, the one or more distributed units are implemented on the same computing device as the middlebox (e.g., as different software modules), and in other cases the one or more distributed units are implemented on one or more other computing devices.

Method 700 continues at block 704, where the middlebox processes the fronthaul traffic. The resulting processed traffic can provide one or more connectivity features. For instance, the one or more connectivity features can include providing a distributed antenna system, providing distributed multiple-input and multiple-output (MIMO) functionality, providing RU sharing among distributed units, and/or providing an application programming interface for accessing scheduling information, signal quality measurements, buffer status, random access attempts, or network load relating to the fronthaul traffic.

Method 700 continues at block 706, where the middlebox communicates the processed fronthaul traffic to the one or more distributed units and the one or more radio units.

### Example Graphical User Interface

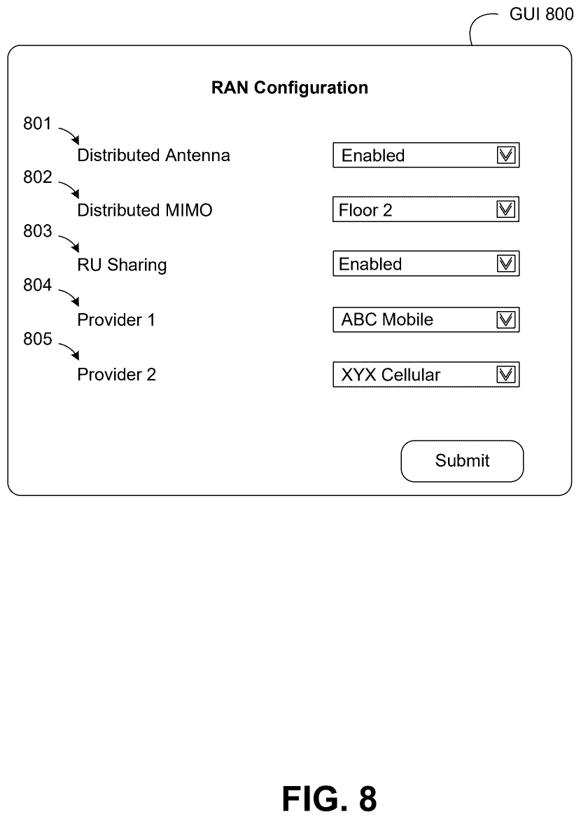

FIG. 8 shows an example graphical user interface 800 that can be provided by the API module 234 on RAN middlebox 120. The graphical user interface can allow an administrator to configure various parameters of RAN 150. For instance, the graphical user interface can include a distributed antenna element 801, a distributed MIMO element 802, an RU sharing element 803, a Provider 1 element 804, and a Provider 2 element 805.

The distributed antenna element 801 can allow a RAN administrator to enable distributed antenna functionality in RAN 150. For instance, when the RAN administrator enables distributed antenna functionality, this can configure the RAN middlebox 120 to implement the packet mirroring and combining features described above with respect to FIGS. 3A and 3B. The distributed MIMO element 802 can allow a RAN administrator to configure the RAN middlebox to provide distributed MIMO at a particular location in the RAN (e.g., a floor of a building) by implementing the antenna port mapping features described above with respect to FIG. 4A. The RU sharing element 803 can allow a RAN administrator to configure the RAN middlebox to provide RU sharing by providing the frequency band allocation and packet multiplexing/demultiplexing features described above with respect to FIG. 5. The RAN administrator can also select specific providers to allocate the RU sharing spectrum to via Provider 1 element 804 and Provider 2 element 804, respectively.

### Technical Effect

As noted previously, RANs have significant advantages over technologies such as WiFi. Because RANs use licensed spectrum that is shared using a centralized approach, RANs can have higher reliability than WiFi. In addition, RANs can leverage the built-in handover features provided by cellular technologies such as 5G, whereas transitioning from one WiFi network to another tends to be inconvenient and/or unreliable.

However, as also noted above, conventional RAN technologies involve vendor-specific, end-to-end solutions. This can be expensive and inflexible. While open, virtualized RAN technologies have changed this to some extent by allowing interoperability among RAN hardware produced by different vendors, certain advance connectivity features are not readily available.

The disclosed implementations provide for advanced connectivity features such as a distributed antenna system, distributed MIMO, and/or RU sharing without necessarily involving any modification or replacement of existing DUs or RUs. By manipulating fronthaul traffic among DUs and RUs in a RAN, these connectivity features can be provided even in scenarios where DUs and RUs are provided by different vendors. Furthermore, RAN capacity can be extended over time by adding new hardware from different vendors, and easily integrated into an existing RAN deployment.

### Device Implementations

As noted above with respect to FIG. 1, system 100 includes several devices, including a client device 102, a client device 104, a client device 106, a client device 108, an RU 112, an RU 114, an RU 116, an RU 118, a RAN middlebox 120, a DU 132, a DU 134, and a CU 142. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions which cause the computing device to provide functionality. Computer-readable instructions and/or data can be stored on storage, such as storage/memory and/or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, solid state drives, and flash memory, among others.

In some cases, the devices are configured with a general purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 160 and/or a RAN implemented by the devices of system 100.

### Additional Examples

Various examples are described above. Additional examples are described below. One example includes a computer-implemented method performed by a middlebox, the computer-implemented method comprising receiving, by the middlebox, fronthaul traffic relating to communications between one or more distributed units and one or more radio units of a radio access network, processing the fronthaul traffic with the middlebox, the processing resulting in processed fronthaul traffic that provides one or more connectivity features in the radio access network, and communicating the processed fronthaul traffic from the middlebox to the one or more distributed units and the one or more radio units.

Another example can include any of the above and/or below examples where the one or more connectivity features include a distributed antenna system.

Another example can include any of the above and/or below examples where the distributed antenna system is provided by associating multiple radio units with an individual distributed unit.

Another example can include any of the above and/or below examples where the processing includes combining user plane data from the multiple radio units, the combining resulting in combined user plane data and sending the combined user plane data to the individual distributed unit.

Another example can include any of the above and/or below examples where the processing includes mirroring user plane packets and control plane packets received from the individual distributed unit to the multiple radio units.

Another example can include any of the above and/or below examples where the one or more connectivity features include distributed multiple-input and multiple-output (MIMO) functionality on the radio access network.

Another example can include any of the above and/or below examples where the distributed MIMO functionality is provided by remapping antenna port identifiers of multiple antennas of a set of two or more radio units.

Another example can include any of the above and/or below examples where the remapping presents a single virtual radio unit to a particular distributed unit, the virtual radio unit having a total number of antennas corresponding to a sum of all antennas in the set of two or more radio units

Another example can include any of the above and/or below examples where the set includes a first radio unit having two first antennas and two first antenna ports and a second radio unit having two second antennas and two second antenna ports, the virtual radio unit having four virtual antennas and four virtual antenna ports.

Another example can include any of the above and/or below examples where the one or more connectivity features involve sharing a particular radio unit among two or more distributed units.

Another example can include any of the above and/or below examples where the processing includes implementing a neutral host on the middlebox, wherein the neutral host supports two or more cellular service providers with different distributed units via the particular radio unit.

Another example can include any of the above and/or below examples where processing includes allocating a particular frequency band to the particular radio unit and allocating each of the two or more distributed units a separate subband of the particular frequency band.

Another example can include any of the above and/or below examples where the processing includes multiplexing messages received via a downlink from the two or more distributed units into a single message and sending the single message to the particular radio unit.

Another example can include any of the above and/or below examples where the processing includes demultiplexing a single message received from the particular radio unit over an uplink into two or more messages and sending the two or more messages to the two or more distributed units.

Another example can include any of the above and/or below examples where the method further comprises providing, by the middlebox, an application programming interface for accessing scheduling information, signal quality measurements, buffer status, random access attempts, or network load relating to the fronthaul traffic.

Another example can include any of the above and/or below examples where the processing provides at least a distributed antenna system connectivity feature, a distributed multiple-input and multiple-output connectivity feature, and a radio unit sharing feature that involves sharing of a particular radio unit among two or more distributed units.

Another example can include a computing device comprising a hardware processing unit and a storage resource storing computer-readable instructions which, when executed by the hardware processing unit, cause the computing device to implement a middlebox configured to receive fronthaul traffic relating to communications between one or more distributed units and one or more radio units of a radio access network, process the fronthaul traffic to implement one or more connectivity features in the radio access network, the processing resulting in processed fronthaul traffic that provides one or more connectivity features in the radio access network, and communicate the processed fronthaul traffic to the one or more distributed units and the one or more radio units.

Another example can include any of the above and/or below examples where the one or more distributed units are implemented on other computing devices.

Another example can include any of the above and/or below examples where the one or more distributed units are implemented on the computing device with the middlebox.

Another example includes a computer-readable storage medium storing computer-readable instructions which, when executed by a processing unit, cause the processing unit to provide a middlebox that performs acts, the acts comprising receiving, by the middlebox, fronthaul traffic relating to communications between one or more distributed units and one or more radio units of a radio access network, processing the fronthaul traffic with the middlebox, the processing resulting in processed fronthaul traffic that provides one or more connectivity features in the radio access network, and communicating the processed fronthaul traffic from the middlebox to the one or more distributed units and the one or more radio units.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method performed by a middlebox, the computer-implemented method comprising:
receiving, by the middlebox, fronthaul traffic relating to communications between one or more distributed units and one or more radio units of a radio access network;
processing the fronthaul traffic with the middlebox, the processing resulting in processed fronthaul traffic that provides one or more connectivity features in the radio access network; and
communicating the processed fronthaul traffic from the middlebox to the one or more distributed units and the one or more radio units.

2. The method of claim 1, wherein the one or more connectivity features include a distributed antenna system.

3. The method of claim 2, wherein the distributed antenna system is provided by associating multiple radio units with an individual distributed unit.

4. The method of claim 3, wherein the processing includes:
combining user plane data from the multiple radio units, the combining resulting in combined user plane data; and
sending the combined user plane data to the individual distributed unit.

5. The method of claim 3, wherein the processing includes:
mirroring user plane packets and control plane packets received from the individual distributed unit to the multiple radio units.

6. The method of claim 1, wherein the one or more connectivity features include distributed multiple-input and multiple-output (MIMO) functionality on the radio access network.

7. The method of claim 6, wherein the distributed MIMO functionality is provided by remapping antenna port identifiers of multiple antennas of a set of two or more radio units.

8. The method of claim 7, the remapping presenting a single virtual radio unit to a particular distributed unit, the virtual radio unit having a total number of antennas corresponding to a sum of all antennas in the set of two or more radio units.

9. The method of claim 8, the set including a first radio unit having two first antennas and two first antenna ports and a second radio unit having two second antennas and two second antenna ports, the virtual radio unit having four virtual antennas and four virtual antenna ports.

10. The method of claim 1, the one or more connectivity features involving sharing a particular radio unit among two or more distributed units.

11. The method of claim 10, wherein the processing includes:
implementing a neutral host on the middlebox, wherein the neutral host supports two or more cellular service providers with different distributed units via the particular radio unit.

12. The method of claim 11, wherein processing includes:
allocating a particular frequency band to the particular radio unit; and
allocating each of the two or more distributed units a separate subband of the particular frequency band.

13. The method of claim 10, wherein the processing includes:
multiplexing messages received via a downlink from the two or more distributed units into a single message; and
sending the single message to the particular radio unit.

14. The method of claim 12, wherein the processing includes:
demultiplexing a single message received from the particular radio unit over an uplink into two or more messages; and
sending the two or more messages to the two or more distributed units.

15. The method of claim 1, further comprising:
providing, by the middlebox, an application programming interface for accessing scheduling information, signal quality measurements, buffer status, random access attempts, or network load relating to the fronthaul traffic.

16. The method of claim 1, wherein the processing provides at least:
a distributed antenna system connectivity feature,
a distributed multiple-input and multiple-output connectivity feature, and
a radio unit sharing feature that involves sharing of a particular radio unit among two or more distributed units.

17. A computing device comprising:
a hardware processing unit; and
a storage resource storing computer-readable instructions which, when executed by the hardware processing unit, cause the computing device to implement a middlebox configured to:
receive fronthaul traffic relating to communications between one or more distributed units and one or more radio units of a radio access network;
process the fronthaul traffic to implement one or more connectivity features in the radio access network, the processing resulting in processed fronthaul traffic that provides one or more connectivity features in the radio access network; and
communicate the processed fronthaul traffic to the one or more distributed units and the one or more radio units.

18. The computing device of claim 17, wherein the one or more distributed units are implemented on other computing devices.

19. The computing device of claim 17, wherein the one or more distributed units are implemented on the computing device with the middlebox.

20. A computer-readable storage medium storing computer-readable instructions which, when executed by a processing unit, cause the processing unit to provide a middlebox that performs acts, the acts comprising:
receiving, by the middlebox, fronthaul traffic relating to communications between one or more distributed units and one or more radio units of a radio access network;
processing the fronthaul traffic with the middlebox, the processing resulting in processed fronthaul traffic that provides one or more connectivity features in the radio access network; and
communicating the processed fronthaul traffic from the middlebox to the one or more distributed units and the one or more radio units.
